(19) United States
(12) Patent Application Publication
(10) Pub. No.: US 2004/0257812 A1
(43) Pub. Date: Dec. 23, 2004

(54) Light source device, method and device for manufacturing the same, and projector

(75) Inventor: Shohei Fujisawa, Matsumoto-shi (JP)

Correspondence Address: OLIFF & BERRIDGE, PLC, P.O. BOX 19928, ALEXANDRIA, VA, 22320, US

(73) Assignee: SEIKO EPSON CORPORATION, Tokyo (JP)

(21) Appl. No.: 10/834,118

(22) Filed: Apr. 29, 2004

(30) Foreign Application Priority Data
May 6, 2003 (JP) 2003-128010

(51) Int. Cl. F21V 21/00

(52) U.S. Cl. 362/263

(57) ABSTRACT

The invention provides a safer and cleaner method for manufacturing a light source device, which makes it possible to improve productivity while reducing the number of necessary parts and manufacturing cost. According to a method for manufacturing a light source device of the invention, the relative position of an ellipsoidal reflector to a lamp frame can be determined to optimize light collection efficiency before joining the lamp frame to the ellipsoidal reflector. With retaining the position, protruded portions of the lamp frame are joined to an inclined plane along a reflective surface on a peripheral back surface of a light-beam-emitting opening of the ellipsoidal reflector by thermocompression bonding. The lamp frame can thus be joined to the ellipsoidal reflector.

### BACKGROUND OF THE INVENTION

1. Field of Invention

The present invention relates to a light source device, a method and a device for manufacturing the same, and a projector.

2. Description of Related Art

Conventionally, projectors have been developed to provide optical modulation of light beams emitted from a light source according to image information so as to enlarge and project an optical image. Such projectors have been used in combination with a personal computer to provide presentations at a meeting, for example. In recent years, such projectors have been also intended for household use to satisfy needs for home theater applications that project movies, and the like, on a large screen.

There have been increasing requirements for small packaging and high luminance for projector devices providing these applications. To meet the requirements it has been proposed to secure a light source device to a frame portion with a spring or heat-resistant adhesive. See, for example, Japanese Unexamined Patent Application Publication No. 2002-107823 (FIG. 8).

### SUMMARY OF INVENTION

The above-described securing method, however, uses spring parts, and requires a number of components and a time-consuming assembly process. In addition, it is difficult to correct the alignment of a second focal point, which is required for using an ellipsoidal mirror, after securing the device with the spring parts. Meanwhile, securing the device with the heat-resistant adhesive requires time for curing the adhesive so as to secure the frame portion to a reflector. Moreover, applying the adhesive gives rise to the need for particular attention to safety issues such as ventilation.

The invention aims to provide a light source device that enhances productivity and reduces cost, a method and device for manufacturing the same, and a projector including the light source device. A light source device according to the invention can include a light emitting tube having a light emitting part emitting light by an electrical discharge between electrodes, and a sealing part provided at each end of the light emitting part. The device can also include a reflector securing the light emitting tube and aligning a light beam emitted from the light emitting tube to a given direction; and a frame part made of a resin material for securing the reflector. The reflector can further include an inclined plane provided along a reflective surface of the reflector on a peripheral back surface of a light-beam-emitting opening. The inclined plane and a protruded portion of the frame part are joined by means of thermocompression bonding.

This configuration of the invention uses thermocompression bonding for securing the reflector to the frame part and requires no spring parts, and thereby reducing the number of necessary parts and assembly cost. Furthermore, thermocompression bonding takes shorter time than bonding with a heat-resistant adhesive for curing, and thereby enhancing operational efficiency. Bonding is performed locally, so little effect is made by heat, and the like, for areas other than spots of bonding. In addition, this configuration uses no adhesive, which improves operational safety.

As for the light source device according to one aspect of the invention, it is preferable that the reflector is cut out to be rectangle as seen from the light-beam-emitting direction, leaving out diagonally opposing rim parts of the reflector.

This configuration of the invention can enable thermocompression bonding for the diagonally opposing rim parts of the reflector in order to secure the reflector to the frame part. Since the reflector is cut out to be generally rectangle leaving out diagonally opposing rim parts, it is possible to reduce the size of the light source device without severely lowering light collection efficiency.

A method for manufacturing a light source device according to the invention can include the following: securing a frame part by using an outline as a reference and providing a reflector joined to a light emitting tube so as to come in contact with the frame part, generating a light beam by reflecting light emitted by the light emitting tube on a reflective surface of the reflector, measuring an illuminance of the previously generated light beam entering an illuminance measuring device through a collective element, adjusting a relative position of the reflector to the frame part so that the previously measured illuminance becomes substantially maximum and determining an optimum position of the reflector, and performing thermocompression bonding by deforming a protruded portion of the frame part by heat and pressure with retaining the previously determined relative position between the frame part and the reflector to be joined to an inclined plane on periphery of the reflector. The light source device can include the light emitting tube having a light emitting part emitting light by an electrical discharge between electrodes, and a sealing part provided at each end of the light emitting part. The device can also include the reflector securing the light emitting tube and aligning a light beam emitted from the light emitting tube to a given direction, and the frame part made of a resin material for securing the reflector.

This method of the invention can make it possible to change the relative position of the reflector to the frame part within the sliding range of the reflector. The position of the reflector is determined to have a substantially maximum illuminance within the sliding range of the reflector in the step of adjusting a relative position. By performing thermocompression bonding with retaining the reflector at a point of the substantially maximum illuminance, it is possible to the light source device, joined to the frame part, providing high light-collection efficiency.

It is preferable that the method for manufacturing a light source device according to one aspect of the invention also includes providing an ellipsoidal mirror as the reflector joined to the light emitting tube and detecting a position of light collection with a transmissive screen positioned in close proximity to a second focal point of the ellipsoidal mirror where the previously generated light beam is collected, and indicating the position of light collection and a designed position of light collection. This method of the invention can adjust the relative position of the reflector to the frame part in the step of adjusting a relative position so that the position of light collection of the reflector to be indicated substantially corresponds with the designed position of light collection. Therefore, it is possible to visibly and easily correct the alignment of the second focal point of the ellipsoidal mirror that is deviated because of a gap between a first focal point of the ellipsoidal mirror and the light emitting tube. This improves efficiency in manufacturing the light source device.

The invention can also be applied to a device for manufacturing a light source device for performing the above-mentioned method for manufacturing. A device for manufacturing a light source device according to the invention includes a frame-part retaining device retaining a frame part that is aligned and secured with a relative position being adjusted by using an outline as a reference, a power source providing a light emitting tube secured to a reflector with power for driving, an input optical system receiving a light beam emitted by the light emitting tube and reflected by the reflector, an illuminance measuring device measuring an illuminance of the light beam entering the input optical system, a positioning part moving the reflector so as to adjust a relative position to the frame part, and a thermocompression device joining the frame part and the reflector by thermocompression bonding.

Here, an example of the input optical system can include an integrator illumination optical system that is used for a projector.

The illuminance measuring device may employ a method for measuring illuminance of images projected on an integrating sphere or a screen.

The device for manufacturing a light source device according to the invention provides a light source device in the same process and with the same effects as the above-mentioned method for manufacturing. Furthermore, applying the light source device for a projector makes it possible to reduce the size, improve productivity, and save manufacturing cost.

### BRIEF DESCRIPTION OF THE DRAWINGS

The invention will be described with reference to the accompanying drawings, wherein like numerals reference like elements, and wherein:

FIG. 1 schematically shows optical systems of a projector according to a first embodiment of the invention;

FIG. 2 is a perspective view schematically showing the configuration of the light source device according to the embodiment;

FIG. 3 is a sectional view showing light-beam emission from the light source device according to the embodiment;

FIG. 4 schematically shows a device for manufacturing the light source device according to the embodiment;

FIG. 5 schematically shows the configuration of the light source device according to the embodiment;

FIG. 6 is a flowchart showing a process for manufacturing the light source device according to the embodiment;

FIG. 7 schematically shows the configuration of a light source device according to a second embodiment of the invention; and

FIG. 8 schematically shows a device for manufacturing the light source device according to the second embodiment of the invention.

### DETAILED DESCRIPTION OF PREFERRED EMBODIMENTS

Embodiments of the invention will now be described with reference to the accompanying drawings.

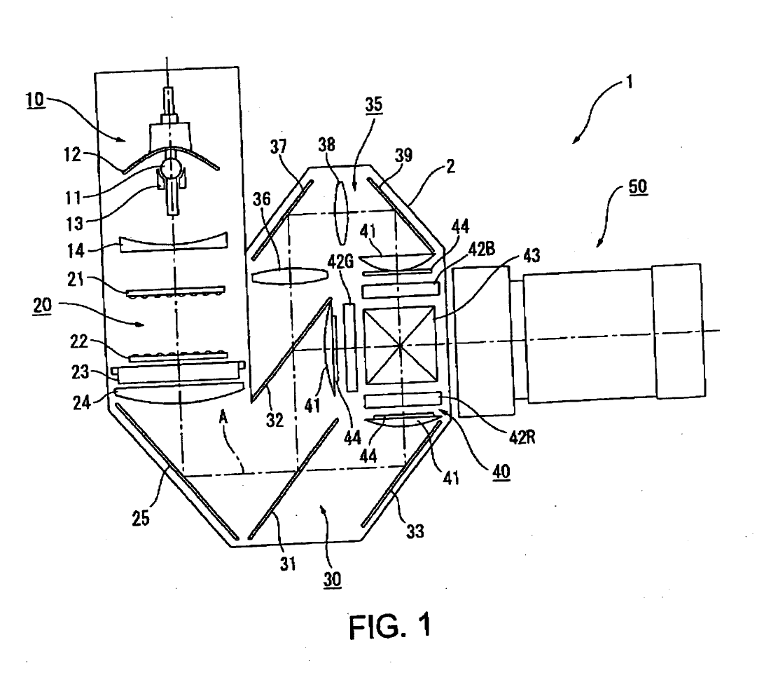

FIG. 1 schematically shows optical systems of a projector 1 according to a first embodiment of the invention. The projector 1 is an optical apparatus providing optical modulation of a light beam emitted from a light source according to image information so as to enlarge and project an image on a screen. The projector 1 can include a light source device 10, an even illumination optical system 20, a color separation optical system 30, a relay optical system 35, an optical device 40, and a projection optical system 50. Optical elements composing the optical systems 20, 30, and 35 are contained with proper alignment in a light guide 2 that have a predetermined illumination optical axis “A”.

The light source device 10 aligns a light beam emitted from a light emitting tube 11 to a given direction, emits the aligned light, and illuminates the optical device 40. The light source device 10, which will be described below in greater detail, includes the light emitting tube 11, an ellipsoidal reflector 12, a secondary reflective mirror 13, and a collimating concave lens 14.

The light beam emitted from the light emitting tube 11 is aligned by the ellipsoidal reflector 12 to be incident toward the front of the device as convergent light, and collimated by the collimating concave lens 14. The light beam then enters the even illumination optical system 20.

The even illumination optical system 20 splits the light beam emitted from the light source device 10 into a plurality of partial beams, and equalizes illuminance in an illuminated area. The even illumination optical system 20 can include a first lens array 21, a second lens array 22, a polarization conversion element 23, an superimposing lens 24, and a reflective mirror 25.

The first lens array 21 performs a function as a beam separation optical element splitting the light beam emitted from the light emitting tube 11 into a plurality of partial beams. The first lens array 21 includes a plurality of small lenses arranged in a matrix on a surface intersecting the illumination optical axis “A”. The outline of each of the small lenses is shaped to be nearly similar to imaging areas of liquid crystal panels 42R, 42G, and 42B included in the optical device 40, which will be described below.

The second lens array 22 is an optical element that collects the plurality of partial beams split by the first lens array 21, together with the superimposing lens 24. Although the second lens array 22 includes a plurality of small lenses arranged in a matrix on a surface intersecting the illumination optical axis “A” like the first lens array 21, it is not necessary for the second lens array 22 to have a shape nearly similar to imaging areas of the liquid crystal panels 42R, 42G, and 42B. This is because the second lens array 22 is to collect light.

The polarization conversion element 23 is an optical element that aligns the polarization direction of each partial beam split by the first lens array 21 to a given direction so as to output linearly polarized light.

The polarization conversion element 23, which is not shown in full detail in the drawing, includes polarization separation membranes and reflective mirrors arranged alternately at an angle to the illumination optical axis “A”. The separation membranes transmits either one of a p-polarized beam and an s-polarized beam included in each partial beam and reflects the other. The reflected polarized beam is further reflected by the reflective mirrors and emitted toward the direction of the transmitted polarized beam, that is the direction along the illumination optical axis “A”. Either of the emitted polarized beams is converted by phase plates provided on a light-beam-emitting surface of the polarization conversion element 23. Consequently, the polarization direction of all the emitted polarized beams is aligned. Thus the polarization conversion element 23 enables the light beam emitted from the light emitting tube 11 to be aligned in a given polarization direction, and thereby increasing the efficiency of light from the light source to be used at the optical device 40.

The superimposing lens 24 is an optical element that collects the plurality of partial beams passing through the first lens array 21, the second lens array 22, and the polarization conversion element 23, and superimposes the beams on imaging areas of the liquid crystal panels 42R, 42G, and 42B. While the superimposing lens 24 is flat on the input side of its beam transmission area and spherical on the output side in this example, the superimposing lens 24 may be an aspheric lens.

The light beam emitted from the superimposing lens 24 is reflected by the reflective mirror 25, and then enters the color separation optical system 30.

The color separation optical system 30 can include two dichroic mirrors 31 and 32, and a reflective mirror 33. The color separation optical system 30 separates the plurality of partial beams emitted from the even illumination optical system 20 through the dichroic mirrors 31 and 32 into red, green, and blue light. The dichroic mirrors 31 and 32 are optical elements on which some light beams of a predetermined range of wavelengths are reflected and other light beams are transmitted. The dichroic mirror 31 placed before the other in the light path transmits red light and reflects light of the other colors. The dichroic mirror 32 placed after the other in the light path reflects green light and transmits blue light.

The relay optical system 35 includes an input lens 36, a relay lens 38, and reflective mirrors 37 and 39. The relay optical system 35 guides blue light passing through the dichroic mirror 32 included in the color separation optical system 30 to the optical device 40. Here, the relay optical system 35 provided in the blue light path, which is longer than the red and green light paths, allows to prevent light efficiency from decreasing because of scattering etc. While this long blue-light-path configuration is employed in this example, the system may have a long red-light path.

Red light separated by the dichroic mirror 31 is reflected by the reflective mirror 33, and then supplied to the optical system 40 through a field lens 41. Green light separated by the dichroic mirror 32 enters the optical system 40 through the field lens 41. Meanwhile, blue light is collected and reflected by the input lens 36, the relay lens 38, and the reflective mirrors 37 and 39, and then supplied to the optical system 40 through the field lens 41. The field lens 41 provided in each color light path in the optical device 40 converts each partial beam emitted from the second lens array 22 into a light beam that is collimated to the illumination optical axis.

The optical device 40 provides optical modulation of an incident light beam according to image information so as to provide color images. The optical device 40 includes liquid crystal panels 42 functioning as an optical modulator to be illuminated, and a cross dichroic prism 43 functioning as a color mixing optical system. Interposed between the field lens 41 and each of the liquid crystal panels 42R, 42G, and 42B is an input polarizing plate 44. In addition, an output polarizing plate, which is not showed in the drawing, is interposed between each of the liquid crystal panels 42R, 42G, and 42B and the cross dichroic prism 43. The input polarizing plate 44, the liquid crystal panels 42R, 42G, and 42B, and the output polarizing plate together perform optical modulation of each color light.

The liquid crystal panels 42R, 42G, and 42B are each formed by sealing liquid crystal, which is an electro-optic material, between a pair of transparent glass substrates, and modulates the polarization direction of polarized beams emitted from the input polarizing plate 44 according to a given image signal using a polysilicon thin-film transistor (TFT) as a switching element. Imaging areas of the liquid crystal panels 42R, 42G, and 42B where optical modulation is performed are rectangle. The diagonal lines of the rectangle are 0.7 inches long, for example.

The cross dichroic prism 43 is an optical element that combines modulated optical images of each color light emitted from the output polarizing plate and form a color image. The cross dichroic prism 43 is formed in the shape of an almost square with four right-angle prisms. A dielectric multilayer film is formed in between every adjacent pair of the right-angle prisms. Such a dielectric multilayer film crosses over another dielectric multilayer film in an X shape. One of the dielectric multilayer films reflects red light and the other reflects blue light. The dielectric multilayer films thus align the direction of reflected red and blue light to that of green light, so as to combine light of the three colors.

The projection optical system 50 enlarges and projects a color image supplied from the cross dichroic prism 43 on a screen, not shown in the drawing, on which a widescreen image is projected.

The light source device 10 is detachable from the light guide 2 and replaceable when the light emitting tube 11 is damaged or the luminance decreases as time elapses.

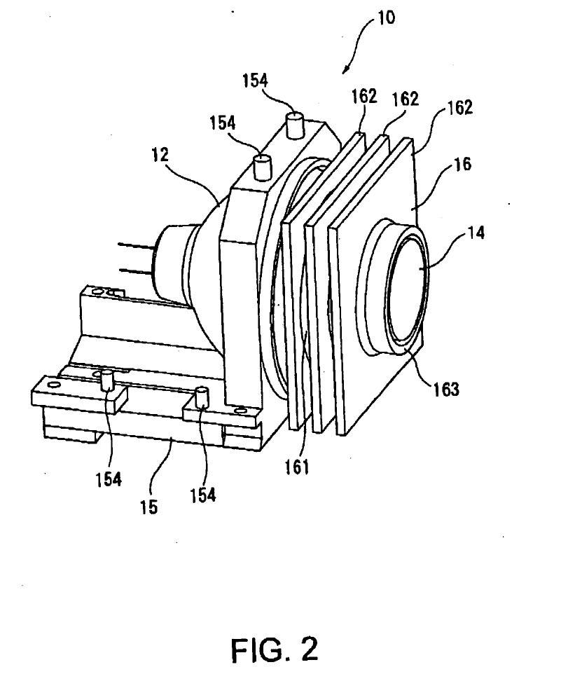

FIG. 2 is a perspective view schematically showing the configuration of the light source device 10. The light source device 10 can include a lamp frame 15 and a cover member 16 as well as the light emitting tube 11, the ellipsoidal reflector 12, the secondary reflective mirror 13, and the collimating concave lens 14.

The ellipsoidal reflector 12 and the lamp frame 15 are joined by thermocompression bonding as will be described later in detail.

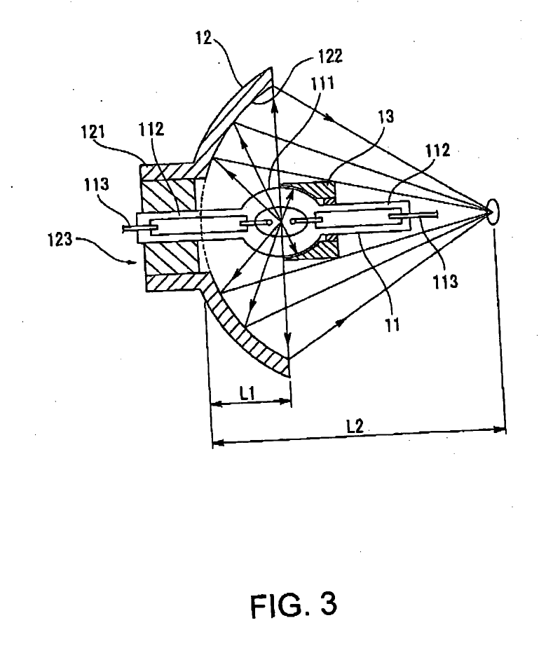

FIG. 3 is a sectional view showing a light source lamp part of the light source device 10 shown in FIG. 2.

The light emitting tube 11 emitting light includes a quartz glass tube with a spherically bloated center. The center is a light emitting part 111. From each side of the light emitting part 111, a sealing part 112 is provided.

Inside the light emitting part 111, a pair of electrodes made of tungsten are provided at a predetermined distance and mercury, noble gas, and a small amount of halogen are enclosed, which are not shown in the drawing.

Inside the sealing part 112, a metal foil made of molybdenum that is electrically coupled to the electrodes included in the light emitting part 111 is sealed with a glass material, or the like. A lead wire 113 as an electrode conductive wire is further coupled to the metal foil. The lead wire 113 extends to the outside of the light emitting tube 11. When a voltage is applied to the lead wire 113, a discharge occurs between the electrodes, and thus the light emitting part 111 emits light.

The ellipsoidal reflector 12 can be a single piece made of glass including a neck part 121 and a reflective part 122 in which the sealing part 112 of the light emitting tube 11 is inserted and a reflective part 122 having a spheroidal surface spreading from the neck part 121. The neck part 121 has an insertion hole 123 at its center. The sealing part 112 is aligned to the center of the insertion hole 123.

The reflective part 122 can be formed by forming a metal thin film by vapor deposition on an inside of the spheroidal glass surface. A reflective surface of the reflective part 122 is formed of a cold mirror that reflects visible light and transmits infrared and ultraviolet rays.

The light emitting tube 11 is provided inside the reflective part 122, and positioned so that the luminescence center between the electrodes included in the light emitting part 111 corresponds with a first focal point L1 of the spheroidal plane of the reflective part 122.

When turning on the light emitting tube 11, a light beam emitted from the light emitting part 111 is reflected on the reflective surface of the reflective part 122 and converged to a second focal point L2 of the spheroidal plane as shown in FIG. 3.

To fit the light emitting tube 11 in the ellipsoidal reflector 12, the sealing part 112 of the light emitting tube 11 is inserted into the insertion hole 123 of the ellipsoidal reflector 12, and aligned so that the luminescence center between the electrodes in the light emitting part 111 corresponds with the first focal point of the spheroidal surface of the reflective part 122. Subsequently, a silica-alumina-based inorganic adhesive is applied to fill the insertion hole 123. Here, the lead wire 113 protruding from the sealing part 112 on the front side is, through the insertion hole 123, exposed to the outside.

The length of the reflective part 122 in the optical axis direction is shorter than the length of the light emitting tube 11. As a result of this securing method of the ellipsoidal reflector 12 to the light emitting tube 11, the sealing part 112 on the front side of the light emitting tube 11 protrudes from a light-beam-emitting opening of the ellipsoidal reflector 12.

The secondary reflective mirror 13 is a reflective member covering nearly the front half in the light-beam-emitting direction of the light emitting part 111 of the light emitting tube 11. The reflective surface of the secondary reflective mirror 13, which is not shown in full detail in the drawing, has a concave curve along the spherical surface of the light emitting part 111, and is made of a cold mirror like the ellipsoidal reflector 12.

By providing the secondary reflective mirror 13 to the light emitting part 111, a light beam emitted to the front side of the light emitting part 111 is reflected by the secondary reflective mirror 13 toward the ellipsoidal reflector 12 and emitted from the reflective part 122 of the ellipsoidal reflector 12 as shown in FIG. 3. Thus, the secondary reflective mirror 13 enables the light beam emitted to the front side of the light emitting part 111 to be reflected back, and thereby aligning the light beam emitted from the light emitting part 111 in a given direction with a small spheroidal surface of the reflective part 122. This makes it possible to reduce the length of the ellipsoidal reflector 12 in the optical axis direction.

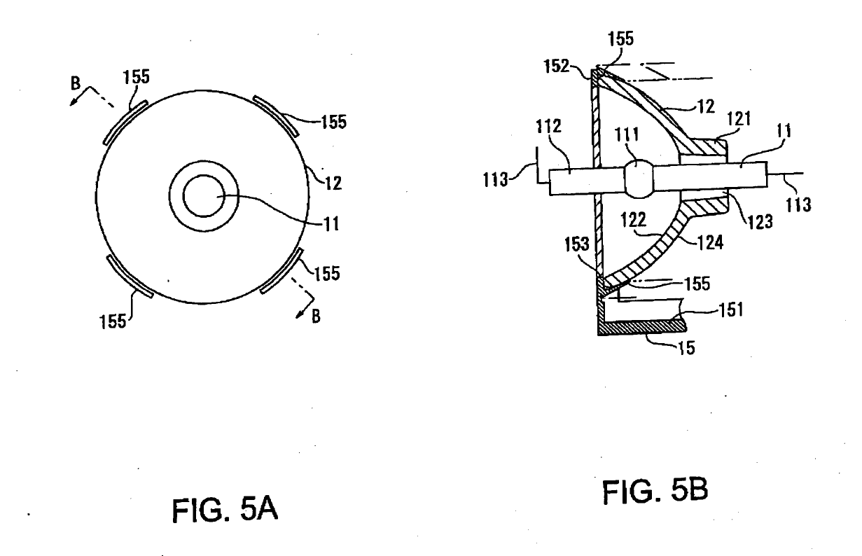

FIG. 5(A) shows the configuration of the light source device 10 according to this embodiment. FIG. 5(B) is a sectional view along the line B-B in FIG. 5(A).

The lamp frame 15 is an L-shaped single piece made of a synthetic resin including a horizontal portion 151 and a vertical portion 152.

The horizontal portion 151 firmly catches a wall of the light guide 2 to retain the light source device 10 in the light guide 2 so that no light will leak. The horizontal portion 151 also includes a terminal block (not shown in the drawing) for electrically coupling the light emitting tube 11 with an external power source. The lead wire 113 of the light emitting tube 11 is coupled to the terminal block.

The vertical portion 152 makes alignment of the ellipsoidal reflector 12 in the optical axis direction. Here, four protruded portions 155 of the vertical portion 152 of the lamp frame 15 are aligned and joined to an inclined plane 124 on the peripheral back surface of the ellipsoidal reflector 12 by thermocompression bonding. Also, the vertical portion 152 has an opening 153 through which a light beam from the ellipsoidal reflector 12 passes.

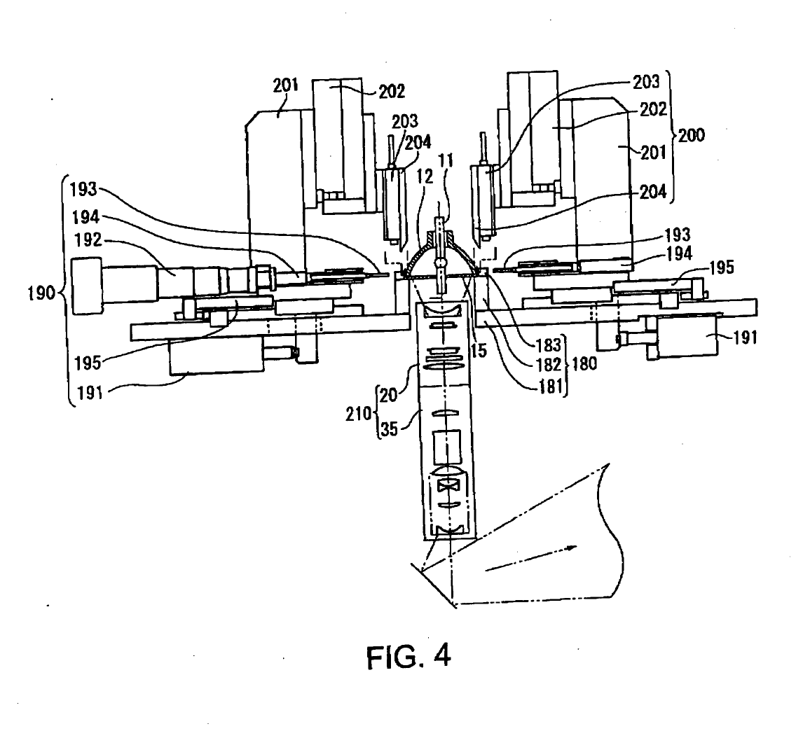

FIG. 4 schematically shows a device for manufacturing a light source device. The manufacturing device includes a base part 180, a positioning part 190 provided on the base part 180, a thermocompression unit 200 provided above the base part 180, an input optical system 210 provided below the base part 180, and a power source for providing a light emitting tube with driving power that is not shown in the drawing. The power source typically rectifies commercial alternating currents with a light source driving circuit (ballast circuit) so as to convert the currents into alternating rectangular currents or direct currents, and drives the light emitting tube.

The base part 180 can include a base 181 that is a horizontal reference plane, a loading jig 182 that extends vertically on the base 181, a lamp frame fixture 183 that secures the lamp frame 15 on the loading jig 182.

First, the lamp frame 15 is fixed on the lamp frame fixture 183. Then, the ellipsoidal reflector 12 to which the light emitting tube 11 is fixed is inserted into an area surrounded by the protruded portions 155 of the vertical portion 152 of the lamp frame 15 (see FIG. 5), so as to enable the ellipsoidal reflector 12 to emit a light beam in the vertical direction.

The base 181 has an opening to transmit a light beam from the ellipsoidal reflector 12 and guide the light beam to the input optical system 210, which will be described in greater detail later.

The loading jig 182 is fixed to each end of the opening. The lamp frame fixture 183 provided on the loading jig 182 secures the lamp frame 15 with the reference outline of the lamp frame 15. The lamp frame fixture 183 secures the lamp frame 15 to have a predetermined relative position between the reference outline of the lamp frame 15 and the optical axis of the input optical system 210.

The positioning part 190 can include an air cylinder 194 coupled to a holding pin 193 at its tip, a micrometer head 192 coupled to the air cylinder at its hedge, a slider 195 on which the air cylinder 194 is mounted at its moving part, and a slider driving device 191 for driving the slider 195. Here, the manufacturing device also includes another positioning part 190 not shown in the drawing as well as the positioning part 190 shown in the drawing, in order to adjust two intersecting horizontal directions in parallel to the base 181.

The air cylinder 194 provides a biasing function. The air cylinder 194 faces another air cylinder, with the lamp frame fixture 183 therebetween. Coupled at the back end of one air cylinder 194 is the micrometer head 192. Each air cylinder 194 is mounted on the slider 195 moving in parallel independently, so as to adjust the holding pin 193 at the tip of each air cylinder 194 moving in the same straight line. When driving the slider driving device 191 of the slider 195, the holding pin 193 moves toward the peripheral back surface of the light-beam-emitting opening of the ellipsoidal reflector 12. Furthermore, by pressurizing the air cylinder 194, the holding pin 193 comes in contact with the ellipsoidal reflector 12 without contacting the protruded portions 155 of the lamp frame 15.

When rotating the micrometer head 192 in this state, the holding pin 193 is protruded. This makes it possible to adjust the relative position of the ellipsoidal reflector 12 to the lamp frame 15 within the sliding range of the ellipsoidal reflector 12.

The thermocompression unit 200 can include a thermocompression jig 204 including a heater 203, an elevating device 202 lifting and lowering the thermocompression jig 204, and an elevating-device platform 201 retaining the elevating device. Here, the manufacturing device also includes another thermocompression unit 200 not shown in the drawing as well as the thermocompression unit 200 shown in the drawing, in order to provide thermocompression bonding in two intersecting horizontal directions in parallel to the base 181. The thermocompression jig 204 of each thermocompression unit 200 is provided without contacting the positioning part 190 while lifting and lowering the elevating device 202.

The input optical system 210 can include optical systems that are substantially the same as the even illumination optical system 20 and the relay optical system 35 of the projector 1. The illuminance of a light beam emitted from the input optical system is measured by an illuminance meter using an integrating sphere provided at the last stage not shown in the drawing or after screen projection.

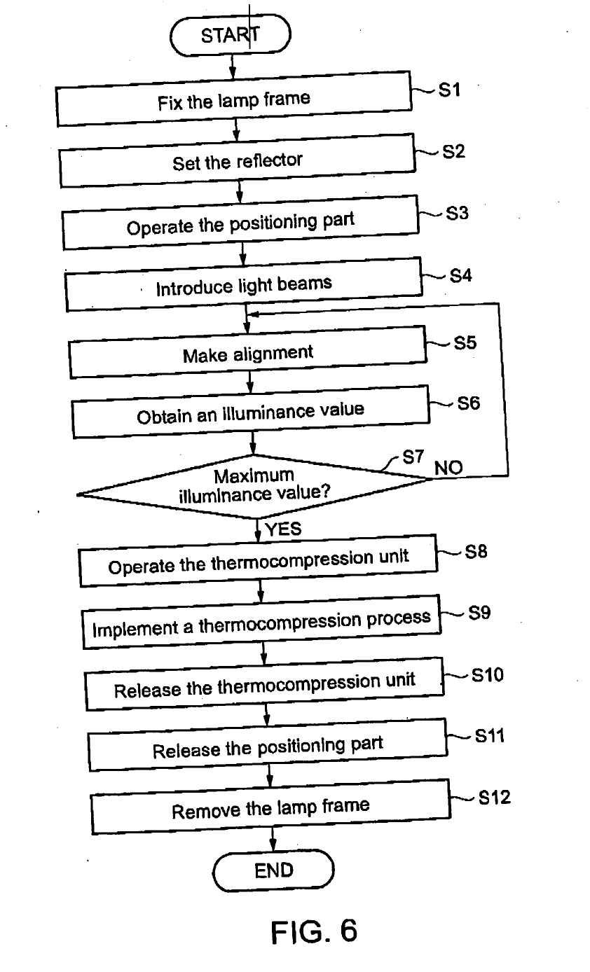

FIG. 6 is a flowchart showing an exemplary process for manufacturing the light source device 10. Referring to FIGS. 4 and 6, a process for joining the lamp frame 15 and the ellipsoidal reflector 12 will now be described.

(1) The lamp frame 15 is placed on the lamp frame fixture 183 (step S1).

(2) The ellipsoidal reflector 12, to which the light emitting tube 11 is fixed, is inserted into an area surrounded by the protruded portions 155 of the vertical portion 152 of the lamp frame 15 (step S2).

(3) Each positioning part 190 provided in two directions is operated (step S3). When driving the slider driving device 191 and pressurizing the air cylinder 194, the holding pin 193 coupled to the tip of the air cylinder 194 comes in contact with the peripheral back surface of the light-beam-emitting opening of the ellipsoidal reflector 12 at four points.

The micrometer head 192 for positioning the holding pin 193 is provided to two intersecting points out of the four points. Using the micrometer head 192 makes it possible to adjust the relative position of the ellipsoidal reflector 12 to the lamp frame 15 within the sliding range of the ellipsoidal reflector 12.

(4) Power for driving a light emitting tube is supplied to the light emitting tube 11 to let the light emitting tube 11 emit light and let converged light that is aligned and emitted by the ellipsoidal reflector 12 enter the input optical system 210 (step S4).

(5) Each micrometer head 192 is operated to adjust the relative position of the ellipsoidal reflector 12 to the lamp frame 15 in the direction of increasing the quantity of light entering the input optical system 210 (step S5).

(6) The illuminance at the relative position of the ellipsoidal reflector 12 to the lamp frame 15 is measured by an illuminance meter provided at the last stage of the input optical system 210 (step S6).

(7) Then, whether the measured illuminance is substantially maximum at the relative position of the ellipsoidal reflector 12 to the lamp frame 15 is judged (step S7).

If the illuminance is judged to be substantially maximum, it is assumed that the relative position of the ellipsoidal reflector 12 to the lamp frame 15 is optimized, which carries the process forward.

If the illuminance tends to increase as the positioning changes, the positioning of the ellipsoidal reflector 12 relative to the lamp frame 15 and the illuminance measurement are carried on.

(8) Each thermocompression jig 204 provided in two directions (at four points) included in each thermocompression unit 200 is heated by providing the heater 203 included in the thermocompression jig 204 with power (step S8).

(9) When lowering the elevating device 202 of the thermocompression unit 200 with retaining the relative position of the ellipsoidal reflector 12 to the lamp frame 15, the thermocompression jig 204 in the moving part of the elevating device is also lowered, thus comes in contact with and pressurizes the protruded portions 155 of the lamp frame 15. Being deformed by heat and pressure, the protruded portions 155 are joined to the peripheral back surface of the light-beam-emitting opening of the ellipsoidal reflector 12 (step S9).

(10) Each elevating device 202 provided in two directions is lifted, and thereby lifting each thermocompression jig 204 at four points (step S10).

(11) Each positioning part 190 provided in two directions is released (step S11). Each air cylinder 194 at four points is depressurized, thereby the contact between the holding pin 193 and the ellipsoidal reflector 12 is released. Subsequently, the slider driving device 191 is set back to the original position.

(12) The lamp frame fixture 183 is removed from the lamp frame 15 and the ellipsoidal reflector 12 that are joined to become a single piece (step S12). Consequently, the lamp frame 15 and the ellipsoidal reflector 12 are joined to become a single piece and provide high light-collection efficiency with the reference outline of the lamp frame 15.

The embodiment can have the following effects. Since the lamp frame 15 and the ellipsoidal reflector 12 are joined by thermocompression bonding, it requires the smaller number of parts and lower assembly cost than a securing method using spring parts.

Since the lamp frame 15 is adjusted and fixed to provide high light-collection efficiency with the reference outline of the lamp frame 15, it is possible to fit the lamp frame 15 to the light source device 10 with the reference plane of the lamp frame 15. The lamp frame 15 is substantially aligned to the optical axis of the light source device 10. Thus, no alignment of the lamp frame 15 in the light source device 10 is required, thereby increasing efficiency in an assembly process.

Joining of the lamp frame 15 and the ellipsoidal reflector 12 by means of thermocompression bonding is completed at the point of releasing the thermocompression jig 204. This requires no time for curing an adhesive, and thereby enhancing productivity.

Moreover, there is no need for particular attention to safety issues while operating such as ventilation, which is required for bonding with an adhesive. The embodiment thus provides a cleaner and safer method.

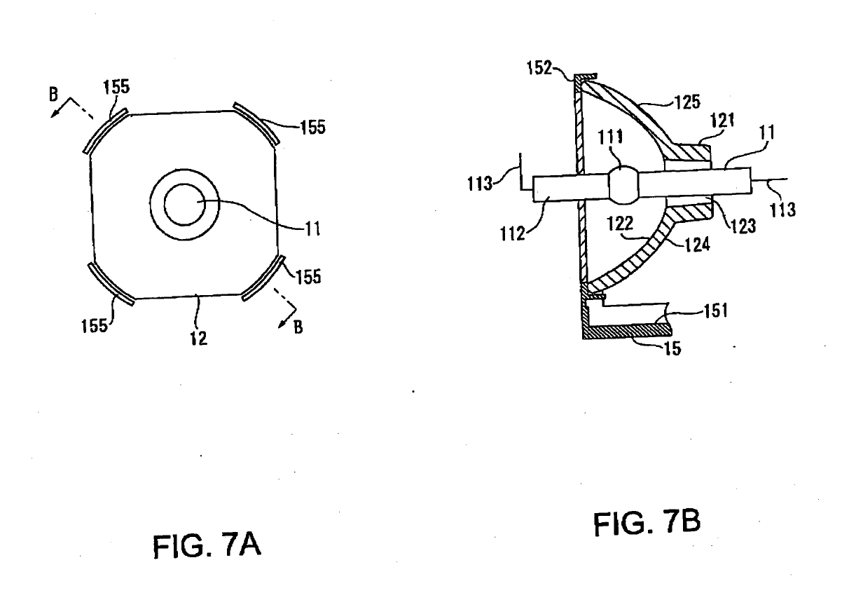

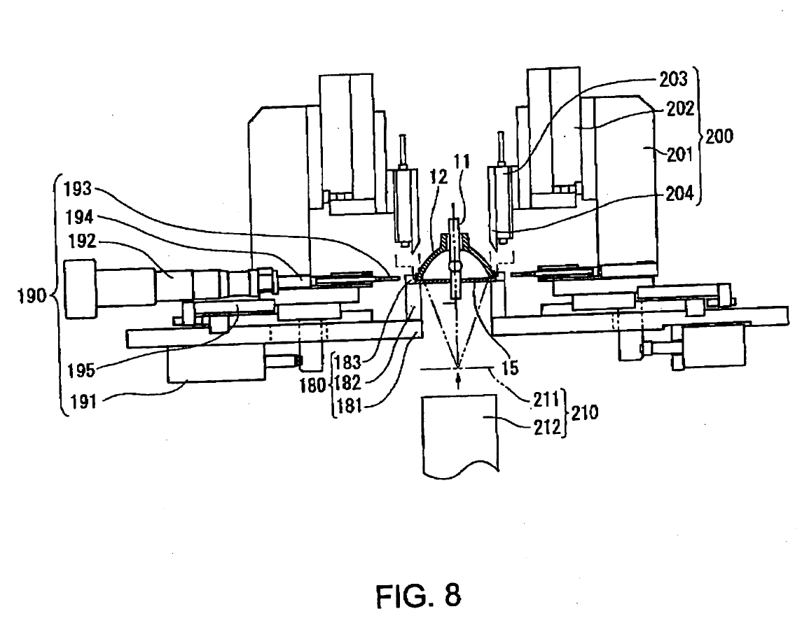

Referring now to FIGS. 7 and 8, a second embodiment of the invention will be described. In the description below, the elements that have mentioned above are marked with the same numerals above and further description of them will be omitted.

FIG. 7(A) shows the configuration of the light source device 10 according to this embodiment. FIG. 7(B) is a sectional view along the line B-B in FIG. 7(A). While the reflective part 122 of the ellipsoidal reflector 12 is circular as seen from the light-beam-emitting direction according to the first embodiment, the reflective part 122 of an ellipsoidal reflector 125 is cut out to be rectangle, leaving out diagonally opposing rim parts of the ellipsoidal reflector in this embodiment. It is possible to apply thermocompression bonding to the lamp frame 15 using the four diagonally opposing rim parts of the ellipsoidal reflector 125 formed in such a shape.

FIG. 8 schematically shows a device for manufacturing the light source device 10. As shown in FIG. 8, the lamp frame 15 and the ellipsoidal reflector 125 are positioned in the same way as in the first embodiment, emitting converged light emitted by the light emitting tube 11 and aligned by the ellipsoidal reflector 125. In this embodiment, a screen 211 is positioned on and around a point where light is converged and in a direction intersecting the optical axis of the converged light. The state of light collection is visible from the back surface. An imaging device 212 takes an image of the state of light collection, indicates a position of the image and a designed position of light collection using a display device not shown in the drawing, and makes an adjustment so that the position of the image substantially corresponds with the designed position of light collection using the positioning part 190. After the adjustment, the lamp frame 15 and the ellipsoidal reflector 125 are joined by the thermocompression unit 200 like in the first embodiment.

This embodiment also has the above-mentioned first to fourth effects of the first embodiment.

It should be understood that the invention is not limited to the above-mentioned embodiments. Various modifications and improvements can be made without departing from the spirit and scope of the invention.

For example, while the reflector used in the first and second embodiments is ellipsoidal, any curved reflector having a curved surface and collecting light can be used instead of the ellipsoidal reflector.

Furthermore, while an operator is to make an adjustment to set an optimum position using the positioning part 190 in the embodiments, it is also possible to make alignment using an automatic positioning device. Here, the automatic positioning device includes a recognition means that automatically recognizes illuminance or the position of light collection, an optimum position calculation means that calculates the optimum relative position of the ellipsoidal reflector 12 to the lamp frame 15 based on data from the recognition means, and an automatic moving means that automatically moves the ellipsoidal reflector 12 to the optimum position based on data from the optimum position calculation means.

Additionally, and as described above, while this invention has been described in conjunction with specific embodiments thereof, it is evident that many alternatives, modifications, and variations will be apparent to those skilled in the art. Accordingly, preferred embodiments of the invention as set forth herein are intended to be illustrative, not limiting. There are changes that may be made without departing from the spirit and scope of the invention.

What is claimed is:

1. A light source device, comprising:
a light emitting tube including:
a light emitting part that emits light by an electrical discharge between electrodes; and
a sealing part provided at each end of the light emitting part;
a reflector that secures the light emitting tube and that aligns a light beam emitted from the light emitting tube to a given direction; and
a frame part that is made of a resin material that secures the reflector;
the reflector including an inclined plane provided along a reflective surface of the reflector on a peripheral back surface of a light-beam-emitting opening, and
the inclined plane and a protruded portion of the frame part being joined by thermocompression bonding.

2. The light source device according to claim 1, the reflector being cut out to be generally rectangle as seen from a light-beam-emitting direction, leaving out diagonally opposing rim parts of the reflector.

3. A method for manufacturing a light source device, comprising:
securing a frame part by using an outline as a reference and providing a reflector joined to a light emitting tube so as to come in contact with the frame part;
generating a light beam by reflecting light emitted by the light emitting tube on a reflective surface of the reflector;
measuring an illuminance of the previously generated light beam entering an illuminance measuring device through a collective element;
adjusting a relative position of the reflector to the frame part so that the previously measured illuminance becomes substantially maximum and determining an optimum position of the reflector; and
performing thermocompression bonding by deforming a protruded portion of the frame part by heat and pressure with retaining the previously determined relative position between the frame part and the reflector to be joined to an inclined plane on periphery of the reflector;
the light source device including the light emitting tube having a light emitting part emitting light by an electrical discharge between electrodes, and a sealing part provided at each end of the light emitting part, the reflector securing the light emitting tube and aligning a light beam emitted from the light emitting tube to a given direction, and the frame part being made of a resin material that secures the reflector.

4. The method for manufacturing the light source device according to claim 3, further comprising:
providing an ellipsoidal mirror as the reflector joined to the light emitting tube and detecting a position of light collection with a transmissive screen positioned in close proximity to a second focal point of the ellipsoidal mirror where the previously generated light beam is collected; and
indicating a position of light collection and a designed position of light collection.

5. A device for manufacturing a light source device, comprising:
a frame-part retaining device that retains a frame part that is aligned and secured with a relative position being adjusted by using an outline as a reference;
a power source that provides a light emitting tube secured to a reflector with driving power;
an input optical system that receives a light beam emitted by the light emitting tube and reflected by the reflector;
an illuminance measuring device that measures an illuminance of the light beam entering the input optical system;
a positioning part that moves the reflector so as to adjust a relative position to the frame part; and
a thermocompression device that joins the frame part and the reflector by thermocompression bonding;
the light source device including the light emitting tube having a light emitting part emitting light by an electrical discharge between electrodes, and a sealing part provided at each end of the light emitting part, the reflector securing the light emitting tube and aligning a light beam emitted from the light emitting tube to a given direction, and the frame part being made of a resin material for securing the reflector.

6. A projector, comprising:
the light source device manufactured with the light source device according to claim 1;
the projector providing optical modulation of a light beam emitted from a light source according to image information so as to form, enlarge, and project an optical image.

7. A projector, comprising:
the light source device manufactured by the method for manufacturing a light source device according to claim 3;
the projector providing optical modulation of a light beam emitted from a light source according to image information so as to form, enlarge, and project an optical image.
